(19) United States
(12) Patent Application Publication
(10) Pub. No.: US 2017/0341056 A1
(43) Pub. Date: Nov. 30, 2017

(54) GC-FTIR and Mode of Operation to Address Water Interference

(71) Applicant: MAX Analytical Technologies, Inc., East Windsor, CT (US)

(72) Inventors: Martin L. Spartz, Ellington, CT (US); Peter P. Behnke, Vernon, CT (US); Kelly Renee McPartland, West Hartford, CT (US)

(21) Appl. No.: 15/601,384

(22) Filed: May 22, 2017

Related U.S. Application Data
(60) Provisional application No. 62/340,833, filed on May 24, 2016.

(51) Int. Cl. B01J 20/287; B01D 11/04; G01N 30/56; G01N 30/74; G01N 30/02

(52) U.S. Cl. CPC B01J 20/287; B01D 11/04; G01N 2030/025; G01N 2030/743; G01N 2030/567

(57) ABSTRACT

Samples are analyzed in a system that includes a gas chromatography column for separating components in a sample and a spectrometry system for detecting these components. An interferent present in the sample, water for example, flows through the column and the sample cell of the spectrometry system before beginning the analysis of analytes.

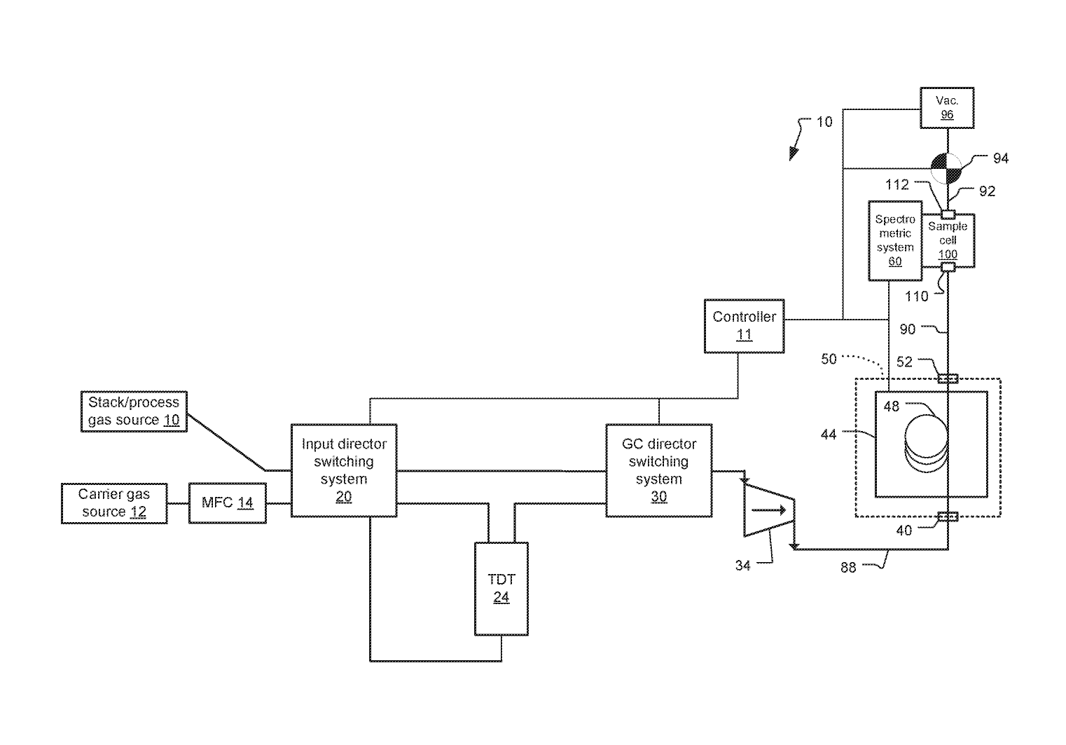

### BACKGROUND OF THE INVENTION

This application claims the benefit under 35 USC 119(e) of U.S. Provisional Application No. 62/340,833, filed on May 24, 2016, which is incorporated herein by reference in its entirety.

### BACKGROUND OF THE INVENTION

Spectrometry-based gas analyzers, such as Fourier transform infrared spectrometry (FTIR) gas analyzers, are becoming common for environmental compliance applications and process gas monitoring, in addition to other gas analysis applications. They are generally good for measuring compounds from 0.1 parts per million (ppm) to a few percent levels in an environmental exhaust, for example. On the other hand, spectrometry-based gas analyzers generally perform poorly when parts per billion (ppb) detection levels are required. Moreover, if too many compounds are present (e.g., greater than 10-20) or too many unknowns are present, the analysis of the spectral data becomes too difficult and the results somewhat questionable.

Gas chromatography (GC) is an analytical method that measures the content of various components in a sample. The method for separating chemical substances relies on differences in partitioning behavior between a flowing mobile phase (gas phase) and a stationary phase supported in a column to separate the components in a mixture. As the gas flow passes through the column, the components of the sample move at velocities that are influenced by the degree of interaction of each component with the stationary phase in the column. Consequently, the different components separate as the components elute from the column.

Gas chromatography can be utilized for many compounds but also has many drawbacks, which include a need for full peak separation to qualify and quantify compounds present, small sample sizes and dynamic ranges, and continuing calibration.

Combined GC-FTIR systems are also known in the industry but are not widely accepted because other GC detectors are more sensitive.

More recently however, a new class of GC-FTIR analysis systems have been proposed. They are characterized by spectrometric sample cells that partially or fully integrate the components/compounds flowing from the GC over time. They use signal analysis techniques to remove the spectral contribution of earlier compound peaks flowing from the GC to identify the currently eluting compounds. Such systems are disclosed, for example, in U.S. Patent Application Publication No. US 2015/0260695 A1 by Spartz, et al., now U.S. Pat. No. 9,606,088, issued Mar. 28, 2017, both of which are incorporated herein by this reference in their entirety.

### SUMMARY OF THE INVENTION

It is often necessary to analyze samples containing large amounts and/or concentrations of water or other similar fluids. For example, the sample could be an aqueous solution or the water could be present as steam or vapor in a gas sample as is common with many exhaust or process gases.

In GC-FTIR analysis systems, water present in the sample can cause significant optical interferences for compounds such as benzene, toluene, or others.

A need exists, therefore, for techniques that address the large absorption peaks caused by water, peaks that can interfere with the detection and/or measurement of volatile organic compounds (VOCs).

Aspects of the invention are practiced by allowing a fluid interferent (e.g., water) to flow through the GC column and sample cell before beginning the analysis of analytes. Many embodiments relate to approaches that aim at enhancing (speeding up, for example) the passage of the interferent through the system, for a faster evacuation.

In specific implementations, the water is derived from a water-containing sample that may also include one or more volatile organic compounds or VOCs, in particular, one or more non-polar VOCs such as benzene, toluene and so forth. Using this water as a carrier medium (also referred to herein as a “carrier fluid” or “carrier gas”) can effect a better GC separation and spectrometric analysis of hazardous or other contaminants.

One embodiment described herein features an analysis method comprising: allowing a fluid interferent from an interferent-containing sample to flow through a gas chromatography column and a sample cell of a spectrometric system before beginning an analysis of analytes.

Another embodiment features an analysis system comprising: a gas chromatography column; and a FTIR spectrometric system having a sample cell, wherein the system is configured to pass an interferent present in a sample through the gas chromatography column and through the sample cell prior to analyzing analytes present in the sample.

In one approach designed to enhance passing and exhausting an interferent from the system, little or no other carrier gas is added to the fluid interferent. For example, as an interferent (e.g., water) flows through the system, use of a primary carrier gas such as nitrogen gas (N₂ can be withheld altogether). In other situations, it is added at a flow rate that is not greater than a flow rate required to prevent back flow of the fluid interferent. Once the source of interferent (e.g., water) has been exhausted or nearly exhausted, a switch to a non-interferent (e.g., non-water) carrier gas, such as a primary N₂ carrier, can be made to complete the analysis.

The system and/or techniques employed can be those disclosed in U.S. Patent Application Publication No. US 2015/0260695 A1 by Spartz, et al., now U.S. Pat. No. 9,606,088 and the sample can be analyzed by an analysis process with a flow-through integrating cell or an analysis process with a static fully integrating cell.

Some embodiments provide a thick non-polar column coatings for the GC column. This can prevent water from acting as a mobile phase for most non-polar species.

Shorter columns can be used to gain a higher flow rate resulting in a more rapid water passage through the GC column. Alternatively or in addition, wider bore capillary columns (such as equal to or greater than 0.53 mm I.D., for example 0.75 mm I.D. and greater) are utilized to obtain higher flow rates and hasten the water removal process.

As compounds of interest elute or are about to elute, a purge or sweep gas such as N₂ can be used to flush remaining water from the sample cell.

According to further examples, techniques disclosed herein can be carried out with or without a focusing trap. In some implementations, the GC column itself, e.g., a column provided with a thick, non-polar coating, essentially functions as a secondary trap.

The invention addresses problems presented by samples that contain an interferant such as water and has many advantages. Embodiments described herein can find applications in source testing, process monitoring, continuous emission monitoring (CEM), hazardous air pollutants (HAP) testing, break through studies, and measurements for various potential compounds. Water vapors that are used as carrier gas can effect a better GC separation of non-polar VOCs. Thick non-polar GC column coatings can prevent water from acting as a mobile phase for most non-polar species.

With the separating column itself being capable of functioning as a secondary trap, implementations described herein can be conducted in the absence of the focusing trap typically used with a GC system. This reduces the number of equipment components needed and associated problems. Losses of analyte during sample splits or as a sample is moved from one thermal desorption tube (TDT) to another are reduced or minimized.

By reducing or eliminating the N₂ carrier flow during the early separation, more water can be supported in the vapor phase and can move through the GC. A steady stream of water moving through the GC will reduce the probability of asymmetric chromatographic peaks, like split, tailing or fronting peaks. This will allow the software to better remove the spectral interference from water and/or other interfering compounds to the analyte, producing better analytical results.

The above and other features of the invention including various details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention.

The Figure is a schematic diagram of a GC-FTIR sample analysis system for detecting and measuring contaminants in water-containing samples.

### DETAILED DESCRIPTION OF THE PREFERRED EMBODIMENTS

Many aspects of the invention relate to a method or system designed to allow a fluid interferent from an interferent-containing sample to flow through a gas chromatography column and a sample cell of a spectrometric system before beginning the analysis of analytes.

As used herein, the term “interferent” refers to a sample component that presents optical features that interfere or obscure optical features characteristic of a compound of interest. In one embodiment, the interferent is water. In a sample being analyzed in a GC-FTIR system such as described by Spartz, et al. in U.S. Patent Application Publication No. US 2015/0260695 A1, now U.S. Pat. No. 9,606,088, it can cause significant optical interference for peaks characteristic of benzene or toluene, for instance.

In specific aspects, the system is configured and/or operated in a manner in which, as the water (or another interferent) is vaporized, from a concentrating device, for instance, it is passed to a GC column (this pathway being the only release for the backpressure) and acts as a carrier fluid, for a period of time, for example. This can effect a better GC separation and spectrometric analysis of hazardous species and/or other contaminants.

In many embodiments, small amounts and sometimes no amounts of additional (or another) carrier fluid (i.e., a carrier fluid other than or different from the interferent) are utilized in conjunction with the interferent. Reducing or eliminating flow of another carrier gas (primary N₂ carrier, for instance) through the column, prevents or minimizes the dilution of the interferent. Since only so much material can move through a capillary column at any given time, low levels or the complete absence of a diluting fluid allow the interferent (e.g., water) to move through and exit the system faster, preferably before starting the analysis of analytes. Thus in many implementations, the interferant is the only carrier gas utilized for a certain time period, for instance, the time period needed to pass it or substantially pass it through the separation column. Other implementations utilize low amounts of an additional carrier fluid, e.g., not greater than needed to prevent back flow of the interferent.

Samples containing an interferent such as water can be derived from a stack or process gas or stream often found in industrial operations. In many embodiments, the sample is collected onto a concentrating device such as a cold or cryo trap, a thermal desorption tube (TDT) or another suitable apparatus. Embodiments described herein also can be practiced by sampling an aqueous solution being introduced by direct injection to an injection port, when off gassing a material containing the interferent, and so forth. Typically, the sample also includes contaminants to be analyzed, VOCs for instance, and in particular non-polar VOC, such as benzene, toluene, other aromatic and aliphatic hydrocarbons, chlorinated and fluorinated hydrocarbons, ethers, esters and sulfides and others.

in an illustrative example, desorption of a water-containing sample collected onto a TDT vaporizes the sample and generates water vapors. Water vapors also can be produced by heating a liquid water-containing sample prior to or upon introducing it to the separating column or by other approaches.

According to some of the techniques described in U.S. Patent Application Publication No. US 2015/0260695 A1, now U.S. Pat. No. 9,606,088, once vaporized, the sample is directed to a GC for example, then to the sample cell of the spectrometric system, e.g., an FTIR system. During one operating mode, a vacuum can be drawn on the sample (gas) cell of the FTIR system until the compound of interest is expected, at which time the gas cell is closed to prevent compound losses. If water elutes before the compounds of interest, and it has already passed through, the compounds can be detected and measured without having to address interferences caused by the presence of water. If overlap exists, however, water peaks can obscure the optical fingerprint characterizing a compound of interest.

For analysis techniques that employ a flow-through integrating sample (gas) cell, a typical residence time is of the order of 2 to 3 minutes. Even if water present in the sample is not expected to concentrate to a significant degree, high levels of water can still present significant problems when the VOC's levels being measured are very low.

Described below are configurations and methods that address situations in which, under typical operating conditions, water elution is not completed by the time components of interest reach the sample cell, causing optical interferences between (strong) spectral peaks characterizing water molecules and spectral features used to identify and preferably also quantify a compound of interest, also referred to herein as an “analyte”. In many cases, amounts of the analyte being investigated are considerably smaller than the water amounts.

Shown in the Figure is an exemplary analysis system 10, including a separator 50 for separating a sample, such as a gas sample, into its components (e.g., separate compounds), a spectrometric system 60 for detecting the spectral response of those compounds in a sample cell 100, and a controller 11 that controls the system and uses the spectral information to identify the compounds of the sample and their concentrations.

The spectrometric system 60 can determine the spectral response of the compounds in sample cell 100 in one or more of the following spectral regions: near-, mid- and/or far-infrared, visible, and/or ultraviolet (UV) (including vacuum ultraviolet (VUV)). Further, the spectrometric system can measure different characteristics, such as absorption spectra, emission (including blackbody or fluorescence) spectra, elastic scattering and reflection spectra, and/or inelastic scattering (e.g., Raman and Compton scattering) spectra of the compounds in the sample cell.

In the case of optical spectrometric systems, for example, different technologies can be employed. In Fourier transform infrared spectrometry (FTIR) systems, single beam spectra are generated by taking the raw interferograms from the FTIR spectrometer and then converting those interferograms to intensity versus wavenumber spectra. In other situations, spectra might be directly read-out as in the case where the spectrometric system 60 is a post dispersive system, which includes a broadband source and a spectrally resolving detector system. In other examples, spectrometric system 60 includes a tunable optical source (e.g., tunable laser) and a detector. Here, the spectral information is a function of the time response of the detector, in such a pre-dispersive system.

In general, spectrometric system 60 is preferably sufficiently sensitive so that by analysis of the spectral information, controller 11 can detect at least some of the sample compounds with low concentration, such as in a few percent to low parts per million (ppm) concentrations, or lower, to parts per billion (ppb).

In a specific embodiment, spectrometric system 60 is a FTIR system. Its sample cell 100, also referred to as “gas cell” 100 is provided with an inlet port 110 for receiving a separator line 90. The sample cell 100 of the spectrometric system 60 has an outlet port 112 for venting the sample cell contents through exit line 92. An exit valve 94 seals and/or controls the flow from the sample cell 100. A vacuum pump 96 can be provided after the exit valve 94 so that a vacuum or partial vacuum can be drawn on the sample cell 100.

The sample cell can have windows made of ZnSe, KBr, BaF₂ or CaF₂, for example, and is fabricated from a suitable material, for instance welded stainless steel. The cell can be configured for multiple-path (also known as multiple-pass or long path) absorption. By increasing the path length traveled, multiple-pass arrangements can be used to measure low concentration components or to observe weak absorption spectral features without increasing the physical length or volume of the cell itself. Since the detection limit of the system is directly related to the volume/path length ratio, decreasing the volume or increasing the path length lowers the concentrations that can be detected. Assuming no signal losses, doubling the path length or reducing the volume in half will lower the detection limit by a factor of 2.

In certain embodiments, longer path lengths are used in combination with higher reflective coatings like enhanced silver, yielding a reflectivity in the 0.992 to 0.995 range or greater. Coating optimizations, in the IR region, for example, could further improve reflectivity. This allows for path lengths that are longer by a factor or 4 to 8 or even more.

Specific implementations utilize a sample cell that is configured as a “White cell” type. The principles of a traditional White cell arrangement employ three spherical concave mirrors having the same radius of curvature. These principles can be modified, to improve image quality and optical throughput, as described, for instance, by Spartz et al. in U.S. Patent Application Publication No. 2015/0260695 A1 (now U.S. Pat. No. 9,606,088). In one example, the White cell type employed uses non-spherical concave mirrors cut onto a single metal or a glass blank, providing a fixed path length; the mirrors can be the solid end caps of the sample cell, allowing for smaller sample cells that are easier to align.

Other multiple pass cell designs that can be utilized include but are not limited to Herriott cells, Pfund cells, cavity-ring down cells, and integrating spheres.

In further examples, the sample cell is a lightpipe flow sample cell.

The sample components are separated in time by separation system 50, which is preferably a gas chromatography system. The GC system has a gas chromatographic column 48. Often the column 48 is coiled in order to minimize overall size while maintaining sufficient tube or column length. Column 48 has a proximate end or inlet 40 for receiving sample from sample inlet line 88 and distal end or outlet 52 for directing resulting product through line 90 to the sample cell 100 for analysis in spectrometry system 60.

The column 48 is typically held within a temperature controlled chamber 44 with a heat source (oven), such as a heating coil that is thermostatically controlled by controller 11 in order to maintain a selected constant temperature during a gas chromatography analysis run. Typically, the heat source also provides sufficient heat to the chamber interior so that the temperature is sufficiently high to ensure that the sample reaches a gaseous state. In one implementation, the column 48 is resistively heated. This avoids the need for the oven. Specifically, column 48 is heated directly by passing a current through the metal column and monitoring the resistance to determine the temperature.

If the compounds of interest (VOCs, for example) are not sufficiently concentrated to be adequately identified and measured in analysis system 10, a sample can be first concentrated prior to separation. In these circumstances, the sample is passed through a concentrator 24, then separated in separation system 50 and then analyzed by spectrometric system 60. Examples of concentrators suitable for such purpose are thermal desorption tubes (TDT) or cold (cryo) traps. Further, if the sample contains trace concentrations, for example in the ppb or parts per trillion (ppt) range, a series of concentrators can be used in analysis system 10. Such configurations allow the same system to be used for a wide variety of samples and sampling conditions.

In one mode of operation, the sample flows through the gas cell 100 and out through the exit valve 94 and multiple spectra are obtained over time by the spectrometric system 60 that integrates the GC effluent sample analyte into the gas cell for a brief period and allows for the possibility of averaging a set of spectra for detection limit reduction, i.e., enhancing detection sensitivity. This can be thought of as an analysis process with flow-through integrating cell.

In another mode of operation, the vacuum pump 96 draws a vacuum on the gas cell 100 and then the exit valve 94 is shut. In this mode, the cell 100 integrates and collects compounds of a sample for a certain time period. Here, the sample cell 100 has been partially or fully evacuated at the beginning of the run. Then, fluid compounds, e.g., components in gaseous phase, are allowed to accumulate in sample cell 100, integrating their spectral signatures. Multiple spectra obtained over a time interval can then be averaged to best measure the integrated concentration in the sample cell. The first spectra are then used as the initial background spectrum and new spectra are obtained as new compounds flow into the integrating sample cell 100. The spectra of the new compounds are obtained by comparing the current spectra to the background spectra. Then this process is repeated. This approach can be thought of as an analysis process with a static fully integrating cell. Further details are provided by Spartz et al., in US Published Patent Application No. 2015/0260695 A1, now U.S. Pat. No. 9,606,088, issued Mar. 28, 2017, both of which are incorporated herein by this reference in their entirety.

System 10 further includes an input director switching system 20 and a GC director switching system 30 for controlling the flow of gases into and out of the TDT 24 and GC 50.

The input director switching system 20 is connected for receiving sample gas from source 10, which can be a process gas or gas from a stack. It also connects to a carrier gas source 12, such as nitrogen, helium or other essentially inert gas that will not interfere with detecting pollutants and other impurities. A mass flow controller (MCF) 14 is preferably provided in-line between the carrier gas source 12 and the input director 20 to control the flow rate of the carrier gas. The input director switching system 20 then selectively connects either of these two sources directly to the GC director switching system 30 or to the TDT 24.

GC director switching system 30 is connected for receiving sample or carrier gas from the input director switching system 20 or gas desorbing from the TDT 24. Output from director switching system 30 then provides gas to GC 50. Possibly a compressor 34 is provided inline between GC director switching system 30 and GC 50.

By control of the input director switching system 20 and the GC director switching system 30, a gas sample can be concentrated in the TDT and then desorbed into GC 50; or, the TDT 24 can be bypassed and the gas sample provided directly to GC 50.

In practice, the functions of controller 11 are often distributed among multiple computer systems. For example, one computer system will often perform the functions of real-time control of the system 10 and collecting and logging the data from the system 10. This includes controlling the flow of gases and liquids throughout the system 10 by controlling one or more MFCs, e.g., MFC 14, input director 20, GC director 30, collection and desorption of TDT 24, valves, e.g., exit valve 94, compressor 34, vacuum pump 96, and separator 50 in addition to the other components of system 10. The real-time control functions further include collecting and recording the spectral information from spectrometric system 60. Then, a second computer system will often be utilized to analyze that data and identify the specific compounds of the sample. This includes analyzing the spectral information and how that information changes over time and recording and reporting the components/compounds present with their concentrations or mass to an operator via a user interface or to another computer. These data are compared with known preset amounts of concentrations (e.g., determined in a calibration procedure) that the spectrometric system 60 is capable of detecting.

When a sample contains significant water levels, the water will typically be present in the chromatogram measured at outlet 52 of column 48 for many minutes. In fact, water can elute from the column 48 for up to 10 to 20 minutes or more, depending on the sample and/or the concentration. When the TDT 24 is used to concentrate the sample, the amount of water is often increased. The level of water collected could exceed the amount of water that can be supported in the vapor phase of the GC column 48, even he column 48 is held at 100° C. or higher.

As an example, if an environmental source is sampled with a TDT at 200 milliliters per minute (mL/min), and that source has 40% absolute moisture, and the TDT 24, is eventually desothed into a 200 mL analyzing chamber (e.g., sample cell 100), it will only take about 2.5 minutes before the chamber will contain the equivalent of 100% water.

For water-containing samples and in particular for aqueous samples (˜100% water) and TDTs with significant amounts of trapped water, the water can be used as a carrier under various operational configurations, as further described below. In some embodiments, water from water-containing samples is used as a carrier fluid during the initial stage of the analysis process.

The following approaches can be used in combination or separately to address absorption peaks from water that can interfere with the measurement of VOCs or other analytes in the sample. These techniques can be applied or adapted to samples containing interferents other than water.

As an illustration referencing the figure, a water-containing sample is obtained from stacklprocess gas source 10, from a liquid introduced at a suitable injection port, etc. The sample is collected in a concentrating device such as TDT 24. For example, the sample is concentrated by control of input director switching system 20 and GC director switching system 30.

The collected water is vaporized, as instructed by controller 11 during the desorption process, as TDT 24 is rapidly heated to release trapped compounds, including water. As vaporized water is generated, it creates a backpressure on GC column 48. To release this backpressure, the flow is through GC column 48 and toward sample cell 100. Specifically, the vaporized water passes through GC director 30, exits into line 88 and enters the proximate end or inlet 40 of GC system 50. Thus the water vapor is now acting as carrier gas for all analytes of interest being transported toward and through the GC column.

In an initial phase of the sample analysis, vacuum pump 96 is activated and exit valve 94 is held open by controller 11. With the vacuum pump pulling on GC column 48, the water flow is increased, attaining, for example, a maximum flow rate. A vacuum is applied in sample cell 100 while water and/or other components (other interferents, for instance) that behave in a similar manner when separated by column 48 (having the same or very similar retention times as water, for example) elute from column 48.

The flow toward and through separation column 48 and sample cell 100 can take place even if the vacuum pump 96 is not employed, as this is the pathway that releases the backpressure. A low flow of N₂ can be utilized to prevent backflow of water into the carrier gas line during sample vaporization or a valve (potentially heated) could be utilized to prevent water condensate from forming and back flowing into the carrier gas line.

One possible implementation utilizes a purge or sweep gas, N₂ from carrier gas source 12, for example, to flush the water vapors from sample cell 100, thus speeding up their removal. Purging can be conducted, for example, before or as compounds of interest are beginning to elute from column 48. If a purge gas is applied, the vacuum pump 96 can be an inexpensive vacuum pump, a diaphragm pump for instance, since a high- or ultra-high vacuum is not required in order to clear out any remaining water from the sample cell.

The purge flow can be terminated (e.g., by MFC 14 under instructions from controller 11) at a time optimized for enhanced water removal combined with reduced or minimized losses of analyte from sample cell 100 (losses caused, for instance, by analyte entrainment in the purge gas). In many cases, the flow of sweep gas is terminated as compounds of interest are expected to elute or are determined as eluting from separating column 48.

Further, controller 11 closes exit valve 94. Contemporaneously or subsequently, controller 11 deactivates vacuum pump 96, ensuring that the compounds of interest are now retained in the gas sample cell 100. The sample being integrated in the sample cell can now be analyzed by the spectrometric system 60 (using an analysis process with a static fully integrating cell) with reduced or without water interferences.

During this initial stage of the process, while water is the carrier fluid, no other or only a relatively small amount of a different carrier gas is allowed to enter TDT 24. In one example, controller 11 controls MFC 14 and blocks the flow of any gas, e.g., primary carrier gas from carrier gas source 12, from entering the TDT and the system is operated in the absence of any added carrier gas. In other situations, a low flow, 0.3 mL/min of N₂, for example, was found to prevent a water interferent from backflowing and condensing in the carrier gas line. Thus if used, the flow rate of a carrier gas employed in addition to the interferent fluid can be selected to have a value no greater than that sufficient to prevent back flow of the interferent fluid. Flow rates required to prevent back flow can be determined experimentally, can be based on experience, prior data, modeling calculations or other approaches. In many cases, the flow rate of N₂ or another added carrier gas used simultaneously with the interferent fluid is within the range of from 0 to less than or equal to about 5% of the flow of interferent fluid. In other cases, the flow rate of the added carrier gas is within the range of from about 0 mL/min to about 0.5 mL/min.

This operational configuration is maintained until compounds of interest are expected to elute from separating column 48. Such a determination can be made based on knowledge of the components of interest and their corresponding chromatogram and/or by spectral analysis of the gases flowing through sample cell 100.

In some implementations, the TDT source pressure is monitored by the controller and used to determine when to turn on the N₂ carrier gas. This can be accomplished by placing a pressure detector on the lines between TDT 24 and inlet 40 to GC column 48 and then monitoring the detected pressure with the help of controller 11. In many cases, the switch to a primary carrier gas other than water, N₂ utilized to complete the analysis, for example, is only made when the water source has been exhausted or nearly exhausted.

Experiments have demonstrated that a compound such as benzene comes off the GC column 48 more than 2 minutes later when using water vapor as the primary initial carrier gas. In one configuration, a typical 10 minute normal retention time for benzene that is observed with an N₂ carrier gas flowing at around 1 mL/min can be extended to 12 minutes for the benzene elution when just water is utilized as the initial carrier gas. This lengthened retention time does not appear to be the result of a reduction in carrier gas flow rate since the maximum flow rate was maintained through the column 48 until most of the water had passed through the column. In fact, adding a carrier gas like N₂ will just slow the water passage down due to dilution. On a 30 m 0.53 mm ID capillary column, about 8.5 mL/mire of N₂ flow rate could be supported as the maximum flow rate. For 200 mL of water vapor stored in TDT 24, for example, using this water as carrier and with no other carrier gas being present, results in an interval of almost 25 minutes for all the water to pass through the GC column 48.

Using the water as the carrier gives rise to further possible approaches for improving the separation of the VOCs, for example, from the water. In some implementations, one or more of: (a) the length of the GC column, (b) the inner diameter of the GC column, and/or (c) the coating thickness of the GC column is/are selected to enhance or facilitate elution and preferably complete elution of the interferent before elution of the analyte.

For example, a shorter column length can be employed to increase the flow rate and expedite the passage of the water through the GC column. In one example, the length of the GC column 48 is no greater than 30 meters (m), e.g., less than or equal to 25 m. In a more specific example, its length is 15 m or less. Using a 0.53 mm internal diameter (I.D.) capillary column could result in a flow rate as high as 19.5 mL/min, evacuating the water present in chromatogram to about 10 minutes in the above example.

Alternatively or in addition to embodiments described above, higher flow rates for enhanced water removal also can be obtained with wider bore capillary columns (such as equal to or greater than 0.53 mm I.D, for instance, 0.75 mm I.D. or greater).

Without the N₂ carrier gas, benzene appears to elute about 2 minutes later on a 10 minute retention time. This is significant because it suggests that there might be a polarity issue present that is normally only seen in liquid chromatography. As the mobile phase and the sample analyte are closer in polarity, the analyte moves faster through the column. In GC, this is not normally the case since the carrier gases generally are non-polar monatomic or diatomic elements.

If a polarity issue is occurring it suggests that water may not be the most effective carrier for pushing a non-polar compound like benzene through the stationary phase. However, if the depth of the stationary phase were to increase, the water would be kept from interacting with the benzene to an even larger extent.

In one implementation, therefore, the GC column is provided with a thick stationary phase. This can allow the system to refocus the VOCs at the head of the column (stuck in the stationary phase) while the water is passing through the column 48 above the stationary phase, toward the system exit valve 94. Then, controller 11 can start the N₂ flow when it is time to perform the actual separation. In this implementation, the coating of the GC column 37 is preferably not less than about 3 micrometer (μm). Examples include coatings of 5 μm or thicker, e.g., to possibly 7 μm thick, for a more optimal separation of the non-polar analytes and water. A thick non-polar column coatings for the GC column is thought to prevent water from acting as a mobile phase for most non-polar species. It is anticipated that a 7 μm DB-1 type coating would provide the most resolving power between polar and non-polar species.

Although using thick stationary phases can tend to broaden peaks, such broader peaks can typically be addressed by integrating or partially integrating analysis techniques described in by M. L. Spartz in U.S. Patent Application Publication No. US 2015/0260695 A1, now U.S. Pat. No. 9,606,088, both being incorporated herein in their entirety by this reference.

Thermal desorption devices often are configured to desorb to a secondary trap, to further concentrate the sample, with a fairly high flow, resulting in a sample that is many times split. The secondary trap is then desorbed and sent to the GC where the sample is split again. At 10 s of mL/min, the GC will only accept 1 or 2 mL/min. Thus each time a TDT or focusing trap is used, sample is lost due to splitting or just passing through the material (unretained).

Specific implementations of the system and/or techniques described herein can be carried out without a focusing trap. Rather, the GC column itself can essentially function as a secondary trap, thus reducing the need for more equipment. In addition, the absence of a focusing trap can potentially reduce analyte losses that arise when analytes are moved from one TDT to another.

In the case in which sample cell 100 is a flow-through integrating cell, exit valve 94 remains open during the analysis process. As a consequence, the amount of water or other interferent can be high but the interferent will not concentrate in cell 100 by more than what a typical, e.g., 2 or 3 minutes, residence time will allow. Even with a flow-through sample cell, the water concentration can still be very high when trying to measure very small VOC concentrations. To address this issue, the flow rate through sample cell 100 can be adjusted, e.g., increased, or the cell can be reconfigured for higher flow rates during time periods when water is eluting from the column 48. For instance, the flow rate can be increased to ensure that the interferent is cleared from the sample cell by the time analytes elute or are about to elute from the gas chromatography column.

Principles outlined above also can be adapted to a dual mode operation such as described, for instance, in U.S. patent application Ser. No. 15/335,618, by M. L. Spartz et al., filed on Oct. 27, 2016, with the title Coupled Analytical Instruments for Dual Mode FTIR/GC-FTIR, incorporated herein by this reference in its entirety.

In one configuration of a dual mode system, while compounds in one sample are being analyzed in real-time or near-real-time_{;} a second sample is being collected, possibly concentrated and otherwise being prepared for separation and analysis. Once the real-time analysis of the first sample is finished, the second sample can be directed to the separation system, which separates the components of the sample in time, and then passes the components on to the spectrometric system for analysis.

Instruments can be configured an reconfigured between a number of different modes of operation, including: 1) direct from sample source to the spectrometric system; 2) concentrate in a concentration device such as on thermal desorption tubes (TDT) or in a cryotrap, then direct to spectrometric system: and 3) optionally concentrate in the concentration device, then through GC and then to the spectrometric system.

The analysis system can be configured for a spectrometric mode in which it performs spectrometric analysis on samples and a separation and spectrometric mode in which it first separates the samples into one or more respective components and then performs spectrometric analysis on the components of the samples. Preferably, the analysis system has a chromatographic system for separating the samples into the components and possibly at least one concentrator for concentrating components from the samples prior to separation.

Specific embodiments employ an analysis system that performs spectrometric analysis on samples simultaneously with concentrating samples for subsequent spectrometric analysis.

In many cases, an analysis system performs spectrometric analysis on samples taken upstream of an abatement system while capturing samples downstream of the abatement system.

A suitable system for dual mode operation includes a spectrometry system for detecting one or more components of the samples, a gas chromatography system for separating the samples into the components, a concentrator for concentrating the samples. The system is configurable for directing the samples: from the sample source to said spectrometry system; and/or from the sample source to the concentrator and directing concentrated samples to the gas chromatography system for separating the sample into the components and directing the separated components to the spectrometry system. The concentrator can be a thermal desorption tube and/or cold trap. In certain implementations, the spectrometry system is a Fourier transform infrared spectrometry system.

The analysis system can be configurable between a first analysis mode and a second analysis mode. The analysis system comprises a spectrometric system for performing spectral analysis and a separator for separating a sample into components, in which, for the first analysis mode, the analysis system is configured for directing a sample to the spectrometric system for spectral analysis, without passing the sample through the separator and for the second analysis mode, the analysis system is configured for directing the sample to the separator prior to directing the sample to the spectrometric system for spectral analysis.

In one example, the system comprises a first sample loop unit and a second sample loop unit; wherein the first and second sample loop units are configured for performing one or more processes concurrently and independently.

In implementations, a first sample concentrator is provided in the first sample loop unit and a second sample concentrator is provided in the second sample loop unit. The first and the second sample loop units are configured for directing respective portions of the sample to the first and second sample concentrators prior to the portions of the sample being directed to the spectrometric system. Typically, each of the first and second sample concentrator is one of: a thermal desorption tube and/or a cryogenic trap.

An analysis method for a dual analysis system typically includes performing spectrometric analysis on samples and first separating the samples into their one or more respective components and then performing spectrometric analysis on the components of the samples.

The analysis system can comprise a separator for separating samples into components, a spectrometric system for performing spectral analysis on the components, and a first sample loop unit and second sample loop unit enabling simultaneous processing of the samples, such one sample unit can be collecting samples while the other is providing the collected samples to the separator.

An input director can be used for directing either source gas or carrier gas to the first sample loop unit and/or the second sample loop unit. Also, a mass flow control (MFC) valve can be used for supplying carrier gas to the concentrating devices.

An analysis method includes alternately collecting samples in a first sample loop unit or second sample loop, after samples have been collected in either of the first sample loop unit or second sample loop, separating the collected samples into components and performing spectral analysis on the components.

In such an arrangement, a water-containing sample collected on a TDT disposed in the sampling loop that is operated in the desorption mode is desorbed and water can be used as a carrier according to one of the embodiments described above. A vacuum pump can be installed on the line exiting the system, for example downstream of a system exit valve.

While this invention has been particularly shown and described with references to preferred embodiments thereof, it will be understood by those skilled in the art that various changes in form and details may be made therein without departing from the scope of the invention encompassed by the appended claims.

What is claimed is:

1. An analysis method comprising:
allowing a fluid interferent from an interferent-containing sample to flow through a gas chromatography column and a sample cell of a spectrometry system before beginning an analysis of analytes.

2. The method of claim 1, wherein a flow rate of another carrier fluid added to the fluid interferent is within the range of from 0 mL/min to about 0.5 mL/min.

3. The method of claim 1, wherein another carrier gas is added to the fluid interferent at a flow rate sufficient to prevent back flow of the fluid interferent,

4. The method of claim 1, wherein a flow rate of another carrier fluid added to the fluid interferent is no greater than about 5% relative to the flow rate of the fluid interferent.

5. The method of claim 1, wherein the interferent is water and the analytes include at least one non-polar volatile organic compound.

6. The method of claim 5, wherein the at least one non-polar volatile organic compound is benzene or toluene.

7. The method of claim 1, wherein the gas chromatography column has a length, an inner diameter and/or a coating thickness selected to enhance complete elution of the interferent before elution of the analyte.

8. The method of claim 1, wherein a length of the gas chromatography column is not greater than about 30 meters.

9. The method of claim 1, wherein an inner diameter of the gas chromatography column is equal to or greater than about 0.53 mm.

10. The method of claim 1, wherein a coating on the gas chromatography column is non-polar and/or has a thickness of at least about 3.0 microns.

11. The method of claim 1, further comprising purging the sample cell to remove remaining water from the cell.

12. The method of claim 1, wherein a switch to a carrier gas other than water is made when the water source has been exhausted or nearly exhausted.

13. The method of claim 1, wherein the sample is desorbed from a concentrating device.

14. The method of claim 13, further comprising monitoring pressure from th concentrating device.

15. The method of claim 1, wherein the method is conducted in the absence of a focusing trap.

16. The method of claim 1, wherein the sample is analyzed in an analysis process with a flow-through integrating cell and the flow of the interferent is adjusted to clear the interferent from the sample cell before analytes elute or are about to elute from the gas chromatography column.

17. The method of claim 1, wherein the sample is analyzed in an analysis process with an integrating cell.

18. The method of claim 1, wherein the sample cell is a multiple pass sample cell.

19. The method of claim 1, wherein the method is conducted in a coupled analytical instrument for dual mode FTIR/GC-FTIR.

20. An analysis system comprising:
a gas chromatography column;
a FUR spectrometric system having a sample cell;
wherein the system is configured to pass an interferent present in a sample through the gas chromatography column and through the sample cell prior to analyzing analytes present in the sample.

21. The system of claim 20, further comprising a concentrating device for collecting and desorbing the sample.

22. The system of claim 20, further comprising a source of a carrier gas for completing the analysis after the water source has been exhausted.

23. The system of claim 20, wherein the GC column has a length, an inner diameter and/or a coating thickness selected to enhance complete elution of the interferent before elution of the analytes.

24. The system of claim 20, wherein the column has a length that is no _{B}rea er than meters.

25. The system of claim 20, wherein the column that has an inner diameter that is equal to or greater than about 0.53 mm.

26. The system of claim 20, wherein the column has a column coating that is non-polar and has a thickness of at least about 3 microns.

27. The system of claim 20, wherein the system oes not include a focusing trap.

28. The system of claim 20, wherein the sample cell is a multiple pass sample cell.

29. The system of claim 20, wherein the system is part of a coupled analytical instrument for dual mode FTIR/GC-FTIR.
